(19) United States
(12) Patent Application Publication
(10) Pub. No.: US 2021/0279736 A1
(43) Pub. Date: Sep. 9, 2021

(54) BLOCKCHAIN SECURE TRANSACTION METHOD AND DEVICE BASED ON BIOMARKER AUTHENTICATION

(71) Applicant: Tsinghua University, Beijing (CN)

(72) Inventor: Weitao Sun, Beijing (CN)

(21) Appl. No.: 17/253,061

(22) PCT Filed: Jul. 6, 2018
(86) PCT No.: PCT/CN2018/094769

§ 371 Date: Dec. 16, 2020

(30) Foreign Application Priority Data
Jun. 4, 2018 (CN) 2018105655296

(51) Int. Cl. G06Q 20/40; G06Q 20/38; G06Q 20/06

(52) U.S. Cl. CPC G06Q 20/40145; G06Q 20/40975; G06Q 20/065; G06Q 20/3829; G06Q 20/3827

(57) ABSTRACT

The embodiments of the present application disclose blockchain secure transaction methods and devices based on biomarker authentication. When a digital transaction voucher for the transaction between the payer and the payee is generated, the legality of the transaction is verified, instead of only using nonce, using the transaction key generated according to the biometric encrypted information of the payee user as the digital transaction voucher of the transaction. It can be guaranteed that the transaction will only occur between the payer and the payee designated by the payer due to the uniqueness of the biometric encrypted information. By the methods above, the legal identity information of the payer and payee to the transaction is authenticated from the perspective of the underlying blockchain information encryption, thereby ensuring that a digital transaction voucher can only be used once in a transaction and avoiding the problem of double spending. In addition, the user's digital assets can be recovered by using the uniqueness of the biometric encrypted information for identity authentication when the user's key is lost or the account is embezzled.

### CROSS-REFERENCE TO RELATED APPLICATION

This application claims priority to Chinese patent application No. 2018105655296 filed on Jun. 4, 2018, entitled “Blockchain Secure Transaction Method and Device Based on Biomarker Authentication,” which is incorporated herein by reference in its entirety.

### FIELD OF TECHNOLOGY

Embodiments of the present application relate to the technical field of secure transactions, and in particular to a blockchain secure transaction method and a device based on biomarker authentication.

### BACKGROUND

Blockchain technology is a method that concatenates data blocks containing transaction information into a linear chained list structure using hash and encryption algorithms and release it on the network. Each data block (block) needs to be formed by commonly encrypting tail block data information of the current blockchain, the current timestamp information and a temporarily generated nonce. This nonce must be able to make the generated encrypted block meets the so-called “partial hash collision” requirement, that is, the first k characters from left to right in the string generated by the secure hash algorithm SHA-256 encryption are all 0. It is generally believed that brute force with massive computing power is the fastest way to find this nonce. In a blockchain network, each node has the right to generate new blocks. After the newly generated block transaction information is confirmed and recorded into the blockchain (it is generally required to be recorded into the blockchain and there are five other blocks behind), the blockchain will be broadcast to each node in the network so as to ensure that each node holds the latest block transaction information. The essential feature of blockchain is the ability to generate end-to-end distributed blocks in the network. The generation of each new block represents a new transaction, and the process of generating a new block has a distributed characteristic. Any two nodes in the network can complete a transaction and generate a new block without the participation of a single central node server. Therefore, the processing capacity of transactions between massive nodes has been greatly improved by blockchain technology.

The blockchain itself operates with a high degree of reliability. The crash of a single node will not affect the transactions between other remaining nodes since the blockchain runs on every node in the network. After the transaction is completed, the blockchain information is shared by the network nodes, so the operation of the database and the entire system is open and transparent and a “public ledger” is established, and deception and tampering of transaction data between nodes are avoided. The block on the blockchain contains all the data information of the previous blocks by the hash and encryption algorithms. If any attempt is made to tamper with a certain block and make the block recognized by most nodes in the network, it is needed to crack encrypted information on all other blocks associated with the block, which requires massive computing power. Thus, such an attempt cannot be achieved under normal circumstances.

Although the current blockchain has many advantages, it also has many disadvantages, such as the problem of double spending. In a blockchain electronic transaction system, the encrypted block is an only voucher to prove the legality of the transaction between the two parties, thus the encrypted digital voucher needs to be made impossible to be tampered with. The payer of a transaction encrypts the transaction information of the last block on the blockchain to form a new block, and adds the new block to the blockchain to acquire the digital voucher of a transaction. The voucher, as part of the blockchain, is broadcast to all nodes of the blockchain network, and is stored in the network as a “public ledger.” However, due to the delay in network communication, it takes a period of time for a new block representing a transaction to be recognized by most network nodes after being generated. During this period of time, it cannot be checked whether the payer has used a new block after the payee of the transaction gets the digital voucher (the new block). In other words, before the legality of the new block is confirmed by the blockchain (it is generally required to be recorded into the blockchain and there are five other blocks behind), the payer can use the block in hand as a digital voucher to pay to multiple payees at will. This is like the user owns a blank check, which can be paid to multiple payees at will before the bank cashes it.

Secondly, the security mechanism of blockchain technology often refers to the reliability and stability mechanism of the blockchain itself, but for traders of digital vouchers, the system architecture does not provide sufficient legal identity authentication and transaction stop-loss mechanism for preventing account take-over. For ordinary users, the so-called “reliability” of the blockchain only provides a 24×7×365 full-time trading platform, but it does not mean that the security of a single user's digital vouchers and assets in transactions has been reliably guaranteed. On the contrary, once the user's key is lost, personal digital assets will be permanently lost in that the system itself does not provide a mechanism to recover legal assets, thus this is an unacceptable security risk for most ordinary users. Therefore, although blockchain technology provides a convenient trading platform, it is still unable to provide a security assurance mechanism for personal assets similar to traditional centralized trading venues (such as banks).

Finally, the blockchain technology that lacks a legal identity authentication mechanism is also facing serious information security problems. It is very difficult to completely recover transaction data and digital currency when the blockchain network suffers network attack, disclosure and theft of private keys, or even network paralysis due to hardware problems. Therefore, it is urgent to establish a guarantee mechanism to ensure the security of individual user transactions and digital assets.

In the process of implementing the embodiments of the present application, the inventor found that in the traditional blockchain-based methods for secure transactions, transactions can be conducted with multiple payees using the digital voucher before the transaction information is broadcast to each node since the digital voucher for the transaction does not contain the payee's information. Among these multiple transactions, only one transaction is the legal transaction, and the others are all fraudulent transactions. On the other hand, the user's digital assets cannot be recovered when the user's key is lost since the user's personal information is not recorded in the public ledger.

### BRIEF SUMMARY

The technical problem to be solved by the present application is how to solve problems in the traditional methods for secure transactions by the blockchain that transactions can be conducted with multiple payees using the digital voucher before the transaction information is broadcast to each node since the digital voucher for the transaction does not contain the payee's information. Among these multiple transactions, only one transaction is a legal transaction, and the others are all false transactions. On the other hand, the user's digital assets cannot be recovered when the user's key is lost since the user's personal information is not recorded in the public ledger.

In view of the technical problems above, an embodiment of the present application provides a blockchain secure transaction method based on biomarker authentication, including:

acquiring first biometric encrypted information corresponding to a target payee after first request information sent by a target payer for a target transaction with the target payee user is received, and generating a transaction key by encrypting according to the first biometric encrypted information;

determining whether prompt information indicating successful verification of the transaction key is received, and when the prompt information is received, acquiring transaction information of the target transaction upon successful completion of the target transaction; and

releasing the transaction information of the target transaction to each network node of the blockchain, so as to record the transaction information of the target transaction at each network node;

wherein the first biometric encrypted information refers to encoded information obtained by performing an encryption operation on the biometric information of the target payee user; and the biometric information includes fingerprints, iris, palm prints or facial features.

An embodiment provides a blockchain secure transaction method based on biomarker authentication, including:

acquiring a transaction key generated according to first biometric encryption information of a payee and an identity code of a user corresponding to a current terminal after first request information sent by a target payer for a target transaction is received; wherein the identity code includes fourth biometric encrypted information of the user corresponding to the current terminal; and

verifying the transaction key according to the fourth biometric encrypted information; and sending prompt information indicating successful verification of the transaction key when the transaction key is successfully verified, and receiving transaction information in which the target transaction has been recorded and information on the successful completion of the target transaction sent from the server;

wherein the fourth biometric encrypted information refers to encoded information obtained by performing an encryption operation on the biometric information of the user corresponding to the current terminal; and the biometric information includes fingerprints, iris, palm prints or facial features.

An embodiment also provides a server, including:

a first acquirer configured to acquire first biometric encrypted information corresponding to a target payee user, and generate a transaction key by encrypting according to the first biometric encrypted information after first request information sent by a target payer for a target transaction with the target payee user is received;

a determiner configured to determine whether prompt information indicating successful verification of the transaction key is received, and when the prompt information is received, acquire the transaction information of the target transaction upon successful completion of the target transaction; and

a recorder configured to release the transaction information of the target transaction to each network node of the blockchain, so as to record the transaction information of the target transaction at each network node;

wherein the first biometric encrypted information refers to encoded information obtained by performing an encryption operation on the biometric information of the target payee user; and the biometric information includes fingerprints, iris, palm prints or facial features.

An embodiment also provides a terminal, including:

a second acquirer configured to acquire a transaction key generated according to first biometric encryption information of a payee and an identity code of a user corresponding to a current terminal after first request information sent by a target payer for a target transaction is received; wherein the identity code includes fourth biometric encrypted information of the user corresponding to the current terminal; and

a verifier configured to verify the transaction key according to the fourth biometric encrypted information; and send prompt information indicating successful verification of the transaction key when the transaction key is successfully verified, and receive transaction information in which the target transaction has been recorded and information on the successful completion of the target transaction sent from the server;

wherein the fourth biometric encrypted information refers to encoded information obtained by performing an encryption operation on the biometric information of the user corresponding to the current terminal; and the biometric information includes fingerprints, iris, palm prints or facial features.

An embodiment also provides an electronic apparatus, including:

at least one processor, at least one memory, a communication interface and a bus; wherein:

the processor, the memory, and the communication interface communicate with each other through the bus;

the communication interface is configured to perform information transmission between the electronic apparatus and a communication device of a terminal device; and

the memory stores program instructions executable by the processor, and the processor calls the program instructions to perform the methods described above.

An embodiment also provides a non-transitory computer readable storage medium, storing computer instructions that cause a computer to perform the method described above.

An embodiment also provides an electronic apparatus, including:

at least one processor, at least one memory, a communication interface and a bus; wherein:

the processor, the memory, and the communication interface communicate with each other through the bus;

the communication interface is configured to perform information transmission between the electronic apparatus and a communication device of a server; and

the memory stores program instructions executable by the processor, and the processor calls the program instructions to perform the methods described above.

An embodiment also provides a non-transitory computer readable storage medium, storing computer instructions that cause a computer to perform the methods described above.

The embodiments of the present application provide blockchain secure transaction methods and devices based on biomarker authentication. When a digital transaction voucher for the transaction between the payer and the payee is generated, the legality of the transaction is verified, instead of only using nonce, using the transaction key generated according to the biometric encrypted information of the payee user as the digital transaction voucher of the transaction. It can be guaranteed that the transaction will only occur between the payer and the payee designated by the payer due to the uniqueness of the biometric encrypted information. By these methods, the legal identity information of the payer and payee to the transaction is authenticated from the perspective of the underlying blockchain information encryption, thereby ensuring that a digital transaction voucher can only be used once in a transaction and avoiding the problem of double spending. In addition, the user's digital assets can be recovered by using the uniqueness of the biometric encrypted information for identity authentication when the user's key is lost or the account is embezzled.

### BRIEF DESCRIPTION OF THE DRAWINGS

In order to more clearly illustrate the technical solutions disclosed in the embodiments of the present application or the prior art, the drawings used in the descriptions of the embodiments or the prior art will be briefly described below. Obviously, the drawings in the following description are only certain embodiments of the present application, and other drawings can be obtained according to these drawings without any creative work for those skilled in the art.

FIG. 1 is a schematic flowchart of a blockchain security transaction method based on biomarker authentication according to an embodiment of the present application;

FIG. 2 is a schematic diagram of a transaction method for legality authentication only by nonce according to another embodiment of the present application;

FIG. 3 is a schematic diagram of a transaction method for legality authentication by both nonce and biometric encrypted information according to another embodiment of the present application;

FIG. 4 is a schematic diagram of biometric encryption and verification based on blockchain accounts according to another embodiment of the present application;

FIG. 5 is a schematic diagram of the LIB format of a data block based on legal identity biomarker according to another embodiment of the present application;

FIG. 6 is a schematic flowchart of a blockchain security transaction method based on biomarker authentication according to another embodiment of the present application;

FIG. 7 is a structural block diagram of a server according to another embodiment of the present application;

FIG. 8 is a structural block diagram of a terminal according to another embodiment of the present application;

FIG. 9 is a structural block diagram of an electronic apparatus according to another embodiment of the present application; and

FIG. 10 is a structural block diagram of an electronic apparatus according to still another embodiment of the present application.

### DETAILED DESCRIPTION

In order to make the object, technical solutions and advantages of the embodiments of the present application clearer, the technical solutions in the embodiments of the present application are clearly and completely described in the following in conjunction with the accompanying drawings in the embodiments of the present application. Obviously, the described embodiments are part of the embodiments of the present application, rather than all of the embodiments. All other embodiments obtained by a person of ordinary skill in the art based on the embodiments of the present application without any creative work belong to the scope of the present application.

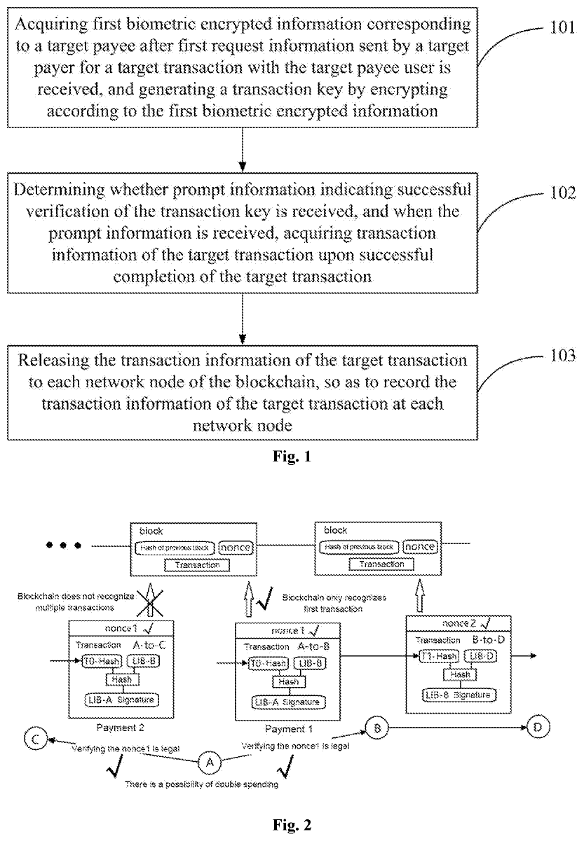

FIG. 1 is a schematic flowchart of a blockchain security transaction method based on biomarker authentication according to an embodiment. Referring to FIG. 1, the method includes:

101: acquiring first biometric encrypted information corresponding to a target payee after first request information sent by a target payer for a target transaction with the target payee user is received, and generating a transaction key by encrypting according to the first biometric encrypted information;

102: determining whether prompt information indicating successful verification of the transaction key is received, and when the prompt information is received, acquiring transaction information of the target transaction upon successful completion of the target transaction; and

103: releasing the transaction information of the target transaction to each network node of the blockchain, so as to record the transaction information of the target transaction at each network node;

wherein the first biometric encrypted information refers to encoded information obtained by performing an encryption operation on the biometric information of the target payee user; and the biometric information includes fingerprints, iris, palm prints or facial features.

The method according to this embodiment is usually performed by a server. The method aims to solve the problem of verifying the legality of the transaction through nonce in the traditional blockchain transaction, which may easily lead to the occurrence of fraudulent transactions. Both the target payer and the target payee users complete the transaction through the terminal (computer or mobile phone). The first biometric encrypted information refers to information corresponding to the fingerprint, iris, palm print or facial features of the target payee user. It is understandable that any biometrics that can uniquely characterize the target payee user belong to the first biometrics, and are not limited to those mentioned above. The transaction key is a key generated according to the first biometrics. For example, the transaction key may be generated by a secure hash encryption algorithm (SHA-512).

In this embodiment, the transaction key is obtained by performing encryption operations on the biometric encrypted information and nonce. The encryption algorithm may be a secure hash encryption algorithm, which is not specifically defined in this embodiment. In this embodiment, the user's biometric information is firstly encrypted to obtain the biometric encrypted information, and the biometric encrypted information is applied in the subsequent transaction process, and thus the problem of information leakage caused by directly using the user's biometric information for transactions is avoided.

By the method according to this embodiment, when information transactions are conducted between the payee and the payer, terminals of the payee and the payer can also directly exchange information, and only the server records the transaction information, the role of the server as a transaction medium is omitted, thus decentralization is enabled and transaction efficiency is improved.

After the transaction key is generated, each terminal will verify whether it is the legal payee of the transaction according to the biometric encrypted information of its corresponding user during the transaction process. If it is the legal payee, the transaction will be performed, otherwise, the transaction will not be performed. Thus it is ensured that the transaction process only occurs between the payer and the payee corresponding to the first biometric encrypted information, so that only one legal transaction can occur before the transaction information is recorded in respective nodes of the blockchain, without fraudulent transaction.

The embodiments provide blockchain secure transaction methods based on biomarker authentication. When a digital transaction voucher for the transaction between the payer and the payee is generated, the legality of the transaction is verified, instead of only using nonce, using the transaction key generated according to the biometric encrypted information of the payee user and the key is used as the digital transaction voucher of the transaction. It can be guaranteed that the transaction will only occur between the payer and the payee designated by the payer due to the uniqueness of the biometric encrypted information. By these methods, the legal identity information of the payer and payee to the transaction is authenticated from the perspective of the underlying blockchain information encryption, thereby ensuring that a digital transaction voucher can only be used once in a transaction and avoiding the problem of double spending. In addition, the user's digital assets can be recovered by using the uniqueness of the biometric encrypted information for identity authentication when the user's key is lost or the account is embezzled.

In an embodiment, on the basis of the foregoing embodiment, the acquiring first biometric encrypted information corresponding to a target payee after first request information sent by a target payer for a target transaction with the target payee user is received, and generating a transaction key by encrypting according to the first biometric encrypted information, includes:

authenticating the target payer by second biometric encrypted information corresponding to the target payer, and when the authenticating the target payer passes, acquiring the first biometric encrypted information corresponding to the target payee after the first request information sent by the target payer for the target transaction with the target payee user is received; and

performing encryption calculation on a generated nonce and the first biometric encrypted information to obtain the transaction key;

wherein the second biometric encrypted information refers to encoded information obtained by performing an encryption operation on the biometric information of the target payee user.

It should be noted that users who conduct transactions through the blockchain have registered biometric encrypted information in advance. When users need to conduct transactions, they can firstly enter the biometric encrypted information for authentication to ensure the security of the payer's assets.

Further, the nonce are numbers that are generated based on timestamp information so that the encrypted block meets the requirement of “partial Hash collision.”

This embodiment provides a blockchain secure transaction method based on biomarker authentication. In the method, the payer is authenticated based on biometric encrypted information before the transaction and thus the security of the payer's assets is ensured.

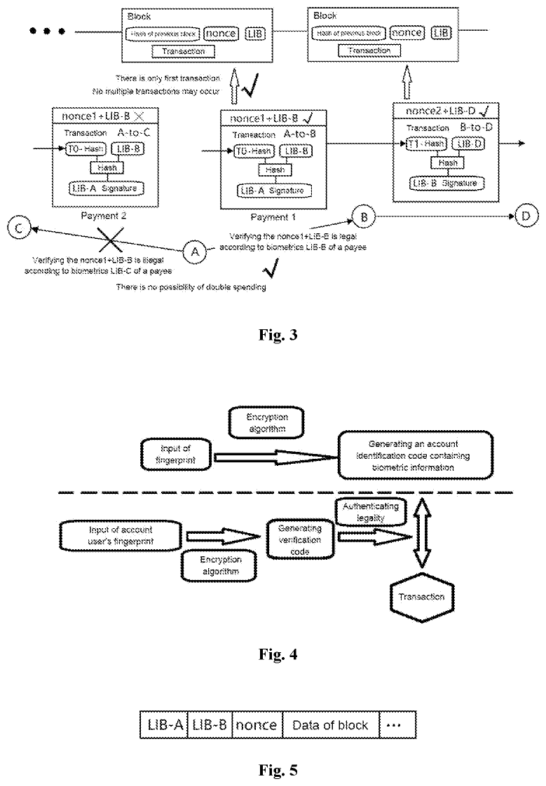

For comparison, in the first aspect, FIG. 2 is a schematic diagram of a transaction method for legality authentication only by nonce; and FIG. 3 is a schematic diagram of a transaction method for legality authentication by both nonce and biometric encrypted information. Referring to FIGS. 2 and 3, methods according to the embodiments are to integrate the biometric authentication information of the payer and payee in the transaction into the underlying block and release it in the blockchain, so as to ensure that users can establish legal transactions in a timely and accurate manner. Traditional blockchain technology provides a distributed timestamp server mechanism by Proof-of-Work, in which the creator of a new block needs to solve a “partial hash collision” problem. It can be guaranteed that the generation time of the block is a time series that is not easy to overlap by the mechanism of cracking this problem through computing power, so as to provide timestamps in a distributed manner. However, when the user finds a valid nonce that meets the requirements of “partial hash collision,” the nonce may be used multiple times (as shown in FIG. 2), which is a defect of current blockchain technology. For example, a user A may use a block for transactions between A and B, and simultaneously, the user A may use this block for transactions between A and C. Since the nonce is the only marker representing the legality of a block, transaction parties B and C can only assume that the block is legal, and cannot determine whether the block has been used multiple times, that is, “double spending” as long as the nonce is valid. The undesirable consequence is that, only the firstly appeared block B is recognized (as shown in FIG. 2), and the other transaction party C has to bear the loss of the fraudulent transaction when the blocks representing the two transactions are loaded into the blockchain.

Digital voucher generation technology for secure transactions based on biometric encrypted information can fundamentally put an end to double transactions. This section is a focus of the entire technical solution of the present application, and is the final implementation of the digital voucher for secure transaction on the blockchain based on the previous steps. The requirement for this step is that a contract is established between the payer and the payee for a legal account on the blockchain and a unique block is generated for the transaction. This block contains the biometric encrypted information of the payer and payee, and this information ensures that the block can only be used once in subsequent legal payments without double spending. Among the above technical solutions, the LIB (Legal Identity Biomarker) format of the blockchain data block based on the transaction biometric encrypted information is an important method invention of the present application.

The module technology has the following characteristics:

(1) The block contains the biometric encrypted information verification mechanism of the payer and the payee. In traditional blockchain technology, the verification of a new block only needs to meet the “partial hash collision” requirement, that is, the user is entitled to use the block to “keep accounts” as long as he finds a nonce satisfying the k first characters of the hash string as 0, without being required a verification of who the block will be delivered to. The potential risk of this mechanism is that the block may be used for multiple transaction payments (see FIG. 2). However, only the first legal transaction among them can be recognized by the blockchain, and other transactions are not recognized. The format of the block containing encrypted biometrics specifies that the block can only be used between the two parties in this transaction (as shown in FIG. 3). The payee can easily verify whether “nonce+LIB” transaction digital voucher provided by the payer has been used for multiple payments based on his own “legal identity biomarker” LIB encryption code. It is a registered digital voucher technology that specifically indicates a clear right relationship between the two paying parties. This technology guarantees “one voucher, one use,” so that it is impossible to use it between third parties, thereby fundamentally avoiding the problem of multiple uses of a block.

(2) The redefined distributed timestamp technology can effectively avoid the furcation of blockchain. The same block will not be paid to two network addresses due to the addition of biometric encrypted information, so that the malicious furcation of blockchain caused by double spending is eliminated.

(3) The digital voucher technology containing the encrypted biometric information of the transaction parties can provide transaction inquiry and digital voucher ownership authentication. According to the “Legal Identity Biomarker” (LIB) technology proposed by the present application, a special format for the LIB data header (as shown in FIG. 5) is provided. The content of the data block includes the unique ID of both parties in the transaction based on biometrics. Users may query and verify the blocks that match the biometric code of their own accounts by the complete and trusted blockchain data kept in the network, may find the legally accepted position in the blockchain using the nonce+LIB hash code, locate the transaction digital voucher related to the account, and authenticate the digital voucher using their own legal and unique biometric identity.

The digital voucher generation technology for secure transactions includes the following points:

(1) Distributed timestamp server technology with encrypted biometric data. The proof-of-work mechanism of the traditional blockchain is to solve a nonce satisfying the “partial hash collision.” The nonce represents the legality of the newly generated block, but it does not require verification of the information of the both parties of the transaction, which is the root cause of the double spending problem. In the distributed timestamp technology of blockchain provided in the present application, the “partial hash collision” problem of “nonce+biometric encryption code” is introduced, so that an identification representing the legality of the newly generated block may reflect legal identities of the two parties of this transaction. Further, the legality of the block may be identified by the authentication mechanism, thereby avoiding one block being used for multiple transactions anonymously. For example, a user A obtains the “nonce+biometric encryption code” (i.e., noncel+LIB-B) that satisfies the “partial hash collision” for the biometric encryption code LIB-B of transaction party B through “mining” (as shown in FIG. 3), and notifies B of the transaction digital voucher containing the digital signature; if user A tries to use the block again to establish a transaction with a user C, the user C may use his own encrypted biometric code LIB-C and noncel to quickly and conveniently generate a hash code, and check whether the digital voucher hash code provided by the user A is specific to this transaction when the user C receives the digital voucher (noncel+LIB-B hash code) representing the legality of the block. Obviously, the hash code of noncel+LIB-B provided by the user A cannot be consistent with the hash code of noncel+LIB-C of the user C. Therefore, the user A fails to double use the digital voucher in hand, and there will be no multiple uses of the block, which fundamentally avoids the “double spending” problem of traditional blockchain technology.

(2) SHA-512 biometric encryption technology is adopted. In the present application, the encryption coding of nonce+biometrics is realized by using the SHA-512 secure hash algorithm. The advantages of this technology are: (a) the confidentiality of data is improved and personal biometrics are prevented from being deciphered; and (b) the upper limit of 21 million digital vouchers in traditional blockchain are broken through, and the number of transaction vouchers is greatly increased.

Further, on the basis of the foregoing embodiments, the method further includes:

acquiring third biometric encrypted information of a target user after second request information for restoring digital assets of the target user sent by any terminal is received, determining digital assets currently belonging to the target user according to transaction information recorded by any node of the blockchain corresponding to the target user, and restoring the digital assets corresponding to the target user.

Since the biometric encrypted information of both parties to the transaction is also recorded as the transaction information is recorded, when the user needs to recover the digital asset, he only needs to acquire his third biometric encrypted information for restoring the asset search the user's transaction record corresponding to the third biometric encrypted information in “public ledger” by the third biometric encrypted information, obtain the user's remaining digital assets based on the transaction record and then recover it.

This embodiment provides a blockchain secure transaction method based on biomarker authentication, in which the user's transaction record can be quickly found from the “public ledger” by biometric encrypted information, the digital assets belonging to the user can be determined, and the user's digital assets can be recovered.

Further, on the basis of the foregoing embodiments, the determining whether a prompt information indicating successful verification of the transaction key is received includes:

sending prompt information indicating that a user currently verifying the transaction key is not the target payee and the transaction is illegal when the prompt information indicating failed verification of the transaction key is received.

It is understandable that a server will send prompt information indicating that the verification of the transaction key fails and this transaction is not allowed to a terminal when the terminal fails to verify the transaction key.

This embodiment provides a blockchain secure transaction method based on biomarker authentication, in which the server sends prompt information to the terminal so that the user can understand the reason for the transaction failure in time.

In a second aspect, specifically, provided is a biometric encryption integration technology of the blockchain account, which has the function of establishing a unique legal account in the blockchain to ensure the security of user transactions. This is the initial module of the entire system and the foundation of subsequent modules. The module technology has the following characteristics:

(1) The biometrics are unique. The biomarkers such as fingerprints, iris, and facial features of the account owner are unique. It is difficult for illegal embezzlers to use the account without the user's knowledge, thereby ensuring the credibility of the transaction object and the authenticity of the transaction result.

(2) Encrypted digital biometrics facilitate information storage, authentication and transmission. Traditional physical credentials are often in the form of photocopying and photographs, which makes it difficult to verify them quickly, automatically and in real time in digital transactions. Biometrics can be quickly digitized, and the encrypted code is used as a legal account identification.

The technical points of the module technology include:

(1) Efficient and secure biometric collection and digital encryption technology. Provided in the present application is the “Legal Identity Biomarker” (LIB) encryption technology, taking fingerprint input as an example, a user's fingerprint information is scanned and input by a hardware device. The fingerprint information is automatically discretized by a SHA-512 secure hash algorithm and encrypted to generate a unique identification code (as shown in FIG. 4).

(2) Legal identity authentication technology in the transaction process. During each transaction, the account user is required to input fingerprints and generate encrypted data. The “legal identity biomarker” is authenticated by comparing the encrypted identification code of the account user with the identification code of the registered user of the account. Only transactions that satisfy identity authentication of the identification code may have legality.

(3) Personal information security technology. The account identification code is a unique identification generated by the SHA-512 secure hash algorithm. It is impossible to reversely obtain the user's biometric encrypted information from the identification, which has extremely high security.

In the third aspect, block legality authentication technology by the blockchain system. The purpose of this technology is to verify the legality of the transaction digital voucher, to ensure that each transaction meets the “one voucher, one use,” and to prevent double spending. It includes the following technical points:

(1) The legality identification technology of digital vouchers in the transaction. After obtaining the legal block, the payer verifies whether the hash codes of the biometric information of the actual transaction parties are consistent according to the biometric encryption code, nonce and hash code of both parties of the transaction contained in the block. The transaction can be authenticated to be legal and added to the tail of the current blockchain only when the information of the both parties of the transaction registered in the digital voucher is consistent with that of the both parties of the actual transaction.

(2) The rapid claiming technology of digital vouchers in the blockchain. Both parties of the transaction need to access a large amount of data when identifying the digital voucher result belonging to this transaction due to the large number of transactions. The transaction result can be quickly identified using unique encoding information in the header of the LIB data block. Therefore, the transaction party does not need to download all the block data, but only needs to download a small number of bytes of the block header to quickly identify and access the transaction information.

This application provides a “legal identity biometrics” secure transaction digital voucher technology system applied to the blockchain that has the characteristics of preventing double spending and fraudulent transactions, authenticating user's digital asset, and high confidentiality of user's personal information. In the case of a large number of blockchain users, a wide range of distribution, and a complex background, this technology is particularly advantageous for protecting personal transactions and asset security. It can prevent asset losses caused by network attacks, account embezzlement and other issues, and improve resistance to malicious damage to the blockchain network. The technology simultaneously retains the characteristics of distributed accounting and decentralized transactions of the blockchain. Compared with the traditional block legality authentication mechanism based on a single nonce, this technology provides for the first time a real-name blockchain secure transaction system associated with personal biometric encrypted information.

In short, the method according to this embodiment includes: firstly, the biometric encrypted integration technology of the blockchain account. This technology helps blockchain users to establish an encrypted account identification number that contains their own unique biometrics. This identification number guarantees the legality of the user's use of the blockchain account, and can be authenticated by fingerprints and other information when the user performs transaction operations, so that the account will not be prevented from being embezzled. Besides, biometrics are encrypted by the SHA-512 encryption algorithm so as to strengthen the security of personal information. Secondly, digital voucher generation technology for secure transactions. This technology helps users who have generated blocks of initiating transactions, and establishing blocks containing the (encrypted) biometrics of both parties of the transaction. Finally, block legality authentication technology by the blockchain system. This technology helps both parties of the transaction to establish a unique and legal transaction, and verifies whether the transaction digital voucher has ever been used, so as to ensure that a complete and legal contract is established between the payer-payee of the transaction in the blockchain, and the blockchain is updated according to the progress of the transaction.

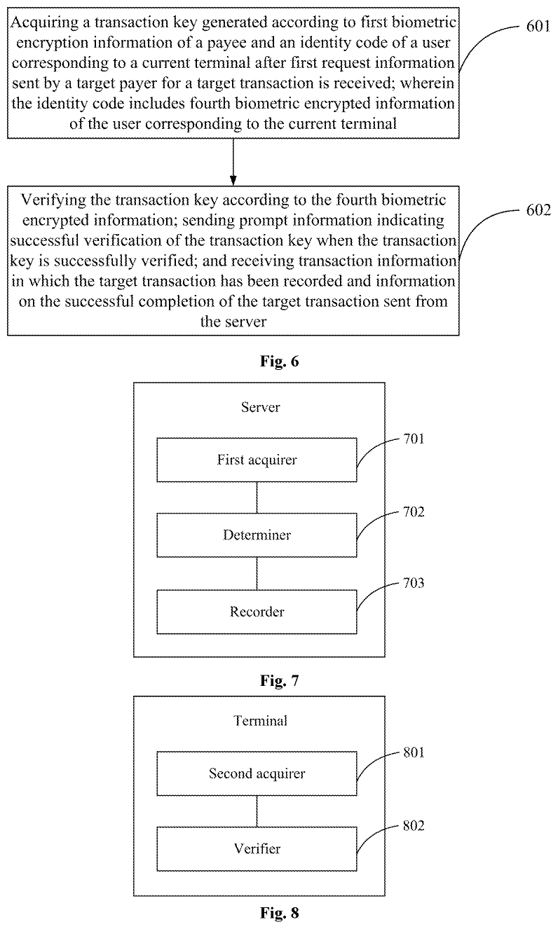

In the method according to this embodiment, a blockchain secure transaction method based on biomarker authentication executed by the terminal when it serves as the payee of the transaction is shown in FIG. 6. The method includes:

601: acquiring a transaction key generated according to first biometric encryption information of a payee and an identity code of a user corresponding to a current terminal after first request information sent by a target payer for a target transaction is received; wherein the identity code includes fourth biometric encrypted information of the user corresponding to the current terminal; and

602: verifying the transaction key according to the fourth biometric encrypted information; and sending prompt information indicating successful verification of the transaction key when the transaction key is successfully verified, and receiving transaction information in which the target transaction has been recorded and information on the success of the target transaction sent from the server;

wherein the fourth biometric encrypted information refers to encoded information obtained by performing an encryption operation on the biometric information of the user corresponding to the current terminal; and the biometric information includes fingerprints, iris, palm prints or facial features.

The embodiments provide blockchain secure transaction methods based on biomarker authentication. When a digital transaction voucher for the transaction between the payer and the payee is generated, the legality of the transaction is verified, instead of only using nonce, using the transaction key generated according to the biometric encrypted information of the payee user as the digital transaction voucher of the transaction. It can be guaranteed that the transaction will only occur between the payer and the payee designated by the payer due to the uniqueness of the biometric encrypted information. By these methods, the legal identity information of the payer and payee to the transaction is authenticated from the perspective of the underlying blockchain information encryption, thereby ensuring that a digital transaction voucher can only be used once in a transaction and avoiding the problem of double spending. In addition, the user's digital assets can be recovered by using the uniqueness of the biometric encrypted information for identity authentication when the user's key is lost or the account is embezzled.

Further, on the basis of the foregoing embodiment, the verifying the transaction key according to the fourth biometric encrypted information includes:

acquiring a nonce generated when the server generates the transaction key, and performing an encryption operation on the nonce and the fourth biometric encrypted information to obtain a code to be verified, wherein it indicates successful verification of the transaction key when the code to be verified is the same as the transaction key; the verification of the transaction key fails when the code to be verified is not the same as the transaction key, and sending a prompt information indicating failed verification of the transaction key.

It should be noted that the terminal has the same encryption algorithm configured to encrypt the biometrics and nonce to generate the transaction key as the server. The acquired biometric encrypted information of the user corresponding to the current terminal is not the original biometric encrypted information, but information obtained after an encryption operation is performed on the biometric information of the user corresponding to the current terminal. Its purpose is to prevent irreparable losses caused by the leakage of users' personal information.

The method according to this embodiment addresses the problems of double spending and insecurity of user's digital asset in blockchain technology and takes into account the complex scope of both parties of transactions on the current blockchain platform, uncontrollable credibility, and inability to guarantee the authenticity and legality of transactions. The technical solution according to this embodiment can have the following objectives:

(1) Establishing a legal identity security authentication technology for digital vouchers of transactions on the blockchain platform. By adding the biometric encrypted information of the both parties of the transaction in the underlying data block, it is guaranteed that one digital voucher can only be used for one transaction and illegal users are prevented from malicious double spending. Encryption technology ensures the authenticity of the legal identity of both parties of the transaction. The SHA-512 secure hash encryption algorithm is applied to technically protect the private information of the object to be accessed and meet the requirements of anonymous transactions. This will also promote more credible and reliable trading results. Therefore, this technology has the functions of protecting the credibility record of both parties of the transaction and protecting the security of personal information.

(2) Establishing a mechanism to prevent trading accounts from being embezzled. In the traditional blockchain technologies, keys are sometimes lost or embezzled, resulting in the loss of users' digital assets. The security of account use can be improved by introducing digital credentials associated with the user's personal biometrics, and account users are required to provide fingerprints and the like for biometric authentication in each transaction, so as to avoid account embezzlement without the user's knowledge.

(3) Establishing a highly confidential mechanism for user's biometric encrypted information. By introducing encrypted biometrics into the underlying block data, any network attack will face the data encrypted by the secure hash algorithm when attempting to obtain encrypted user biometric information, and thus cannot view the original identity information, ensuring that none of the both parties of the transaction and any third parties have the right to obtain and view the user's biological information.

The method according to this embodiment, authenticates the legal identity information of the both parties of the transaction from the perspective of the underlying blockchain information encryption, and ensures that a digital transaction voucher can only be used once in a transaction and thus the problem of double spending is avoided with respect to a series of problems in the traditional blockchain technology. This technology can avoid fraudulent transactions, so that the digital voucher is reliable and tamper-resistant. It also provides a biometric (such as fingerprints) identity authentication mechanism that helps users recover digital assets when the user's key is lost or the account is embezzled.

On the basis of this system, it is convenient to develop a portable mobile terminal-based biometric identity authentication system client, thereby realizing the rapid popularization of user-friendly blockchain technology. The end-to-end digital transaction platform based on this system can quickly promote the development of enterprises and help them build credibility. It is worth pointing out that the legal identity authentication mechanism and the centralized/decentralized mechanism are two independent concepts and can be mutually supportive. Traditional centralized trading platforms (such as banks) provide a complete identity authentication mechanism, requires users to provide legal identity authentication documents (such as ID cards, passports), and ensure the security of users' assets through the identity authentication mechanism. The legal identity authentication mechanism is the security technology of the traditional centralized trading platform, but this does not mean that the identity authentication is the centralized trading system itself, and it is just a means to protect the security of the account used in the centralized trading process. Identity authentication mechanisms can also be used in decentralized blockchain technology. The security of user's digital assets compatible with end-to-end transactions can be provided by the biometric identity authentication mechanism according to the present application. The method according to this embodiment is conducive to the development of the legal identity authentication technology of the decentralized trading platforms, and efficient, reliable, massive, and transparent integrity cloud data can be formed with the help of blockchain technology. This is of great significance for establishing new payment and consumption models based on corporate's and personal credibility, and is one of the hot applications of blockchain technology in the social and economic fields.

Finally, the method according to this embodiment can be further extended in application, and has the advantages of verification of user's identity legality, high account security, standardized and credible transaction process, and strong security of user's digital assets and the like. This method is an important development of the traditional blockchain technology, and has the following beneficial effects:

(1) On the basis of this technical system, a portable mobile terminal-based blockchain transaction system can be developed to rapidly authenticate biometrics such as fingerprints and facial recognition by the terminal, such that the blockchain application system is faster and more convenient.

(2) On the basis of this technical system, a convenient and practical blockchain payment system can be established. Settlement can be made faster by the direct transaction payment system between individuals, and a stable and highly credible blockchain user group can be formed.

(3) Efficient and convenient capital management and flow can be made by enterprises through this technical system, which is conducive to promoting the active and healthy development of enterprises.

(4) The historical records of user transaction data in the blockchain can help establish cloud data on corporate's and personal credibility, which can be used as the basis for user credibility requirements in related industries.

FIG. 7 is a structural block diagram of a server according to this embodiment. Referring to FIG. 7, the server includes a first acquirer 701, a determiner 702, and a recorder 703, wherein

the first acquirer 701 is configured to acquire first biometric encrypted information corresponding to a target payee user, and generate a transaction key by encrypting according to the first biometric encrypted information after first request information sent by a target payer for a target transaction with the target payee user is received;

the determiner 702 is configured to determine whether prompt information indicating successful verification of the transaction key is received, and when the prompt information is received, acquire the transaction information of the target transaction upon successful completion of the target transaction; and

the recorder 703 is configured to release the transaction information of the target transaction to each network node of the blockchain, so as to record the transaction information of the target transaction at each network node;

wherein the first biometric encrypted information refers to information on fingerprints, iris, palm prints or facial features according to the target payee user.

The server according to this embodiment is applicable to the blockchain secure transaction method based on biomarker authentication executed by a server according to the embodiment mentioned above, and will not be repeated here.

The server according to this embodiment may be a distributed timestamp server.

The embodiments provide servers. When a digital transaction voucher for the transaction between the payer and the payee is generated, the legality of the transaction is verified, instead of only using nonce, using the transaction key generated according to the biometric encrypted information of the payee user as the digital transaction voucher of the transaction. It can be guaranteed that the transaction will only occur between the payer and the payee designated by the payer due to the uniqueness of the biometric encrypted information. By these methods, the legal identity information of the payer and payee to the transaction is authenticated from the perspective of the underlying blockchain information encryption, thereby ensuring that a digital transaction voucher can only be used once in a transaction and avoiding the problem of double spending. In addition, the user's digital assets can be recovered by using the uniqueness of the biometric encrypted information for identity authentication when the user's key is lost or the account is embezzled.

FIG. 8 is a structural block diagram of a terminal according to this embodiment. Referring to FIG. 8, the terminal includes a second acquirer 801 and a verifier 802, wherein

the second acquirer 801 is configured to acquire a transaction key generated according to first biometric encryption information of a payee and an identity code of a user corresponding to a current terminal after first request information sent by a target payer for a target transaction is received; wherein the identity code includes fourth biometric encrypted information of the user corresponding to the current terminal; and

the verifier 802 is configured to verify the transaction key according to the fourth biometric encrypted information; and send prompt information indicating successful verification of the transaction key when the transaction key is successfully verified, and receive transaction information in which the target transaction has been recorded and information on the successful completion of the target transaction sent from the server;

wherein the fourth biometric encrypted information refers to encoded information obtained by performing an encryption operation on the biometric information of the user corresponding to the current terminal; and the biometric information includes fingerprints, iris, palm prints or facial features.

The terminal according to this embodiment is applicable to the blockchain secure transaction method based on biomarker authentication executed by a terminal according to the embodiment mentioned above, and will not be repeated here.

The embodiments provide a terminal. When a digital transaction voucher for the transaction between the payer and the payee is generated, the legality of the transaction is verified, instead of only using nonce, using the transaction key generated according to the biometric encrypted information of the payee user as the digital transaction voucher of the transaction. It can be guaranteed that the transaction will only occur between the payer and the payee designated by the payer due to the uniqueness of the biometric encrypted information. By these methods, the legal identity information of the payer and payee to the transaction is authenticated from the perspective of the underlying blockchain information encryption, thereby ensuring that a digital transaction voucher can only be used once in a transaction and avoiding the problem of double spending. In addition, the user's digital assets can be recovered by using the uniqueness of the biometric encrypted information for identity authentication when the user's key is lost or the account is embezzled.

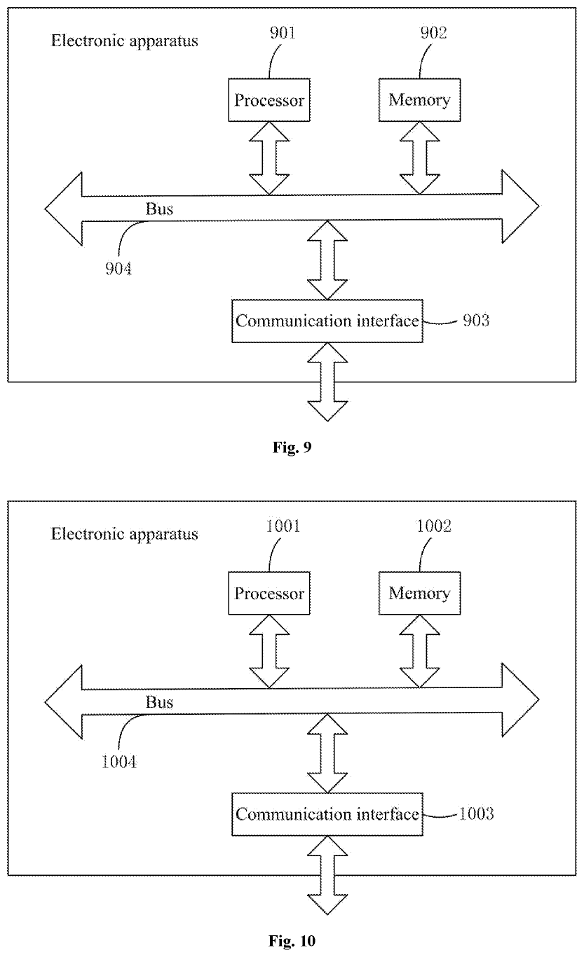

FIG. 9 is a structural block diagram showing an electronic apparatus according to an embodiment of the present application.

Referring to FIG. 9, the electronic apparatus includes a processor 901, a memory 902, a communication interface 903 and a bus 904;

wherein

the processor 901, the memory 902, and the communication interface 903 communicate with each other through the bus 904;

the communication interface 903 is configured to perform information transmission between the electronic apparatus and a communication device of a terminal device; and

the processor 901 is configured to call the program instructions in the memory 902 to perform the methods according to the embodiments mentioned above, for example, including: acquiring first biometric encrypted information corresponding to a target payee after first request information sent by a target payer for a target transaction with the target payee user is received, and generating a transaction key by encrypting according to the first biometric encrypted information; determining whether prompt information indicating successful verification of the transaction key is received, and when the prompt information is received, acquiring transaction information of the target transaction upon successful completion of the target transaction; and releasing the transaction information of the target transaction to each network node of the blockchain, so as to record the transaction information of the target transaction at each network node; wherein the first biometric encrypted information refers to encoded information obtained by performing an encryption operation on the biometric information of the target payee user; and the biometric information includes fingerprints, iris, palm prints or facial features.

This embodiment provides a non-transitory computer-readable storage medium in which computer instructions are stored and the computer instructions cause a computer to perform the methods according to the embodiments mentioned above, for example, including: acquiring first biometric encrypted information corresponding to a target payee after first request information sent by a target payer for a target transaction with the target payee user is received, and generating a transaction key by encrypting according to the first biometric encrypted information; determining whether prompt information indicating successful verification of the transaction key is received, and when the prompt information is received, acquiring transaction information of the target transaction upon successful completion of the target transaction; and releasing the transaction information of the target transaction to each network node of the blockchain, so as to record the transaction information of the target transaction at each network node; wherein the first biometric encrypted information refers to encoded information obtained by performing an encryption operation on the biometric information of the target payee user; and the biometric information includes fingerprints, iris, palm prints or facial features.

This embodiment discloses a computer program product including computer programs stored on a non-transitory computer-readable storage medium. The computer programs include program instructions. When the program instructions are performed by a computer, the computer performs the methods according to the embodiments mentioned above, for example, including: acquiring first biometric encrypted information corresponding to a target payee after first request information sent by a target payer for a target transaction with the target payee user is received, and generating a transaction key by encrypting according to the first biometric encrypted information; determining whether prompt information indicating successful verification of the transaction key received, and when the prompt information is received, acquiring transaction information of the target transaction upon successful completion of the target transaction; and releasing the transaction information of the target transaction to each network node of the blockchain, so as to record the transaction information of the target transaction at each network node; wherein the first biometric encrypted information refers to encoded information obtained by performing an encryption operation on the biometric information of the target payee user; and the biometric information includes fingerprints, iris, palm prints or facial features.

FIG. 10 is a structural block diagram showing an electronic apparatus according to an embodiment of the present application.

Referring to FIG. 10, the electronic apparatus includes a processor 1001, a memory 1002, a communication interface 1003 and a bus 1004;

wherein

the processor 1001, the memory 1002, and the communication interface 1003 communicate with each other through the bus 1004;

the communication interface 1003 is configured to perform information transmission between the electronic apparatus and a communication device of a server; and

the processor 1001 is configured to call the program instructions in the memory 902 to perform the methods according to the embodiments mentioned above, for example, including: acquiring a transaction key generated according to first biometric encryption information of a payee and an identity code of a user corresponding to a current terminal after first request information sent by a target payer for a target transaction is received; wherein the identity code includes fourth biometric encrypted information of the user corresponding to the current terminal; and verifying the transaction key according to the fourth biometric encrypted information; and sending prompt information indicating successful verification of the transaction key when the transaction key is successfully verified, and receiving transaction information in which the target transaction has been recorded and information on the successful completion of the target transaction sent from the server; wherein the fourth biometric encrypted information refers to encoded information obtained by performing an encryption operation on the biometric information of the user corresponding to the current terminal; and the biometric information includes fingerprints, iris, palm prints or facial features.

This embodiment provides a non-transitory computer-readable storage medium in which computer instructions are stored, and the computer instructions cause the computer to perform the methods according to the embodiments mentioned above, for example, including: acquiring a transaction key generated according to first biometric encryption information of a payee and an identity code of a user corresponding to a current terminal after first request information sent by a target payer for a target transaction is received; wherein the identity code includes fourth biometric encrypted information of the user corresponding to the current terminal; and verifying the transaction key according to the fourth biometric encrypted information; and sending prompt information indicating successful verification of the transaction key when the transaction key is successfully verified, and receiving transaction information in which the target transaction has been recorded and information on the successful completion of the target transaction sent from the server; wherein the fourth biometric encrypted information refers to encoded information obtained by performing an encryption operation on the biometric information of the user corresponding to the current terminal; and the biometric information includes fingerprints, iris, palm prints or facial features.

This embodiment discloses a computer program product including computer programs stored on a non-transitory computer-readable storage medium. The computer programs include program instructions. When the program instructions are performed by a computer, the computer performs the methods according to the embodiments mentioned above, for example, including: acquiring a transaction key generated according to first biometric encryption information of a payee and an identity code of a user corresponding to a current terminal after first request information sent by a target payer for a target transaction is received; wherein the identity code includes fourth biometric encrypted information of the user corresponding to the current terminal; and verifying the transaction key according to the fourth biometric encrypted information; and sending prompt information indicating successful verification of the transaction key when the transaction key is successfully verified, and receiving transaction information in which the target transaction has been recorded and information on the successful completion of the target transaction sent from the server; wherein the fourth biometric encrypted information refers to encoded information obtained by performing an encryption operation on the biometric information of the user corresponding to the current terminal; and the biometric information includes fingerprints, iris, palm prints or facial features.

It can be understood by a person skilled in the art that all or part of the steps of implementing the method embodiments above may be completed by using hardware related to the program instructions. The foregoing program may be stored in a computer readable storage medium, and the program performs foregoing steps including the method embodiments above when executed. The foregoing storage medium includes: a medium that can store program codes, such as a ROM, a RAM, a magnetic disk, or a compact disk.

Embodiments of the electronic apparatus described above are merely illustrative, wherein the units described as separate components may or may not be physically separate, and the components displayed as units may or may not be physical units, that is, may be located at the same place, or they can be distributed to multiple network units. Some or all of the modules may be selected according to actual needs to achieve the purpose of the solution of the embodiment. Those of ordinary skill in the art can understand and implement the embodiments described above without paying creative labors.

Through the description of the embodiments above, those skilled in the art can clearly understand that the various embodiments can be implemented by means of software and a necessary general hardware platform, and of course, by hardware. Based on such understanding, the technical solution of the present application or a part of the technical solution, which is essential or contributes to the prior art, may be embodied in the form of a software product, which is stored in a storage medium such as ROM/RAM, magnetic discs, compact discs, etc., including several instructions to cause a computer device (which may be a personal computer, server, or network device, etc.) to perform various embodiments or a part of the methods described in various embodiments.

Finally, it should be noted that the above embodiments are only used to explain the technical solutions of the present application, and are not limited thereto; although the present application is described in detail with reference to the foregoing embodiments, it should be understood by those skilled in the art that they can still modify the technical solutions described in the foregoing embodiments and make equivalent substitutions to a part of the technical features and these modifications and substitutions do not depart from the spirit and scope of the technical solutions of the embodiments of the present application.

1. A blockchain secure transaction method based on biomarker authentication, the method comprising:
acquiring first biometric encrypted information corresponding to a target payee after first request information sent by a target payer for a target transaction with the target payee user is received, and generating a transaction key by encrypting according to the first biometric encrypted information;
determining whether prompt information indicating successful verification of the transaction key is received, and when the prompt information is received, acquiring transaction information of the target transaction upon successful completion of the target transaction; and
releasing the transaction information of the target transaction to each network node of the blockchain, so as to record the transaction information of the target transaction at each network node;
wherein the first biometric encrypted information refers to encoded information obtained by performing an encryption operation on the biometric information of the target payee user; and the biometric information includes fingerprints, iris, palm prints or facial features.

2. The method of claim 1, wherein the acquiring first biometric encrypted information corresponding to a target payee after first request information sent by a target payer for a target transaction with the target payee user is received, and generating a transaction key by encrypting according to the first biometric encrypted information comprises:
authenticating the target payer by second biometric encrypted information corresponding to the target payer, and when the authenticating the target payer passes, acquiring the first biometric encrypted information corresponding to the target payee after the first request information sent by the target payer for the target transaction with the target payee user is received; and
performing encryption calculation on a generated nonce and the first biometric encrypted information to obtain the transaction key;
wherein the second biometric encrypted information refers to encoded information obtained by performing an encryption operation on the biometric information of the target payee user.

3. The method of claim 1, further comprising:
acquiring third biometric encrypted information of a target user after second request information for restoring digital assets of the target user sent by any terminal is received, determining digital assets currently belonging to the target user according to transaction information recorded by any node of the blockchain corresponding to the target user, and restoring the digital assets corresponding to the target user.

4. The method of claim 1, wherein the determining whether prompt information indicating successful verification of the transaction key is received comprises:
sending prompt information indicating that a user currently verifying the transaction key is not the target payee and the transaction is illegal when the prompt information indicating failed verification of the transaction key is received.

5. (canceled)

6. (canceled)

7. A server, comprising:
a first acquirer configured to acquire first biometric encrypted information corresponding to a target payee user, and generate a transaction key by encrypting according to the first biometric encrypted information after first request information sent by a target payer for a target transaction with the target payee user is received;
a determiner configured to determine whether prompt information indicating successful verification of the transaction key is received, and when the prompt information is received, acquire the transaction information of the target transaction upon successful completion of the target transaction; and
a recorder configured to release the transaction information of the target transaction to each network node of the blockchain, so as to record the transaction information of the target transaction at each network node;
wherein the first biometric encrypted information refers to encoded information obtained by performing an encryption operation on the biometric information of the target payee user; and the biometric information includes fingerprints, iris, palm prints or facial features.

8. A terminal, comprising:
a second acquirer configured to acquire a transaction key generated according to first biometric encryption information of a payee and an identity code of a user corresponding to a current terminal after first request information sent by a target payer for a target transaction is received; wherein the identity code includes fourth biometric encrypted information of the user corresponding to the current terminal; and
a verifier configured to verify the transaction key according to the fourth biometric encrypted information; and send prompt information indicating successful verification of the transaction key when the transaction key is successfully verified, and receive transaction information in which the target transaction has been recorded and information on the successful completion of the target transaction sent from the server;
wherein the fourth biometric encrypted information refers to encoded information obtained by performing an encryption operation on the biometric information of the user corresponding to the current terminal; and the biometric information includes fingerprints, iris, palm prints or facial features.

9. An electronic apparatus, comprising:
at least one processor, at least one memory, a communication interface and a bus; wherein:
the processor, the memory, and the communication interface communicate with each other through the bus;
the communication interface is configured to perform information transmission between the electronic apparatus and a communication device of a terminal device; and
the memory stores program instructions executable by the processor, and the processor calls the program instructions to perform the method according to claim 1.

10. A non-transitory computer readable storage medium, storing computer instructions that cause a computer to perform the method according to claim 1.

11. The terminal of claim 8, wherein the second acquirer is further configured to acquire a nonce generated when the server generates the transaction key; and the verifier is further configured to perform an encryption operation on the nonce and the fourth biometric encrypted information to obtain a code to be verified, wherein it indicates successful verification of the transaction key when the code to be verified is the same as the transaction key; the verification of the transaction key fails when the code to be verified is not the same as the transaction key, and send prompt information indicating failed verification of the transaction key.
